(19) United States
(12) Patent Application Publication
(10) Pub. No.: US 2026/0154074 A1
(43) Pub. Date: Jun. 4, 2026

(54) METHOD AND APPARATUS WITH SCALAR-TO-VECTOR BINARY INSTRUCTION TRANSLATION

(71) Applicant: Samsung Electronics Co., Ltd., Suwon-si (KR)

(72) Inventors: Wooseok YI, Suwon-si (KR); Hyungwoo LEE, Suwon-si (KR); Chisung BAE, Suwon-si (KR)

(73) Assignee: Samsung Electronics Co., Ltd., Suwon-si (KR)

(21) Appl. No.: 19/020,823

(22) Filed: Jan. 14, 2025

(30) Foreign Application Priority Data
Sep. 30, 2024 (KR) 10-2024-0133322

(51) Int. Cl. G06F 9/30

(52) U.S. Cl. CPC G06F 9/30036; G06F 8/52; G06F 9/30054; G06F 9/3016; G06F 9/30174; G06F 9/45516

(57) ABSTRACT

A binary instruction translation method includes: receiving and decoding an instruction stream including instructions and pieces of instruction-information respectively corresponding to the instructions; determining whether the instructions in the instruction stream are translatable into a vector instruction stream based on the pieces of instruction-information; and based on a result of the determining, translate the instructions of the instruction stream to a vector instruction stream, the translating including translating at least some of the instructions of the instruction stream to vector instructions in a vector-specific instruction set by replacing scalar instructions of a first instruction set architecture (ISA) with functionally equivalent vector instructions of a vector-specific ISA.

### CROSS-REFERENCE TO RELATED APPLICATIONS

This application claims the benefit under 35 USC § 119(a) of Korean Patent Application No. 10-2024-0133322 filed on Sep. 30, 2024, in the Korean Intellectual Property Office, the entire disclosure of which is incorporated herein by reference for all purposes.

### BACKGROUND

### 1. Field

The following description relates to a method and apparatus with binary compilation.

### 2. Description of Related Art

A reduced instruction set computer (RISC) with an open-source instruction set architecture (e.g., instruction set architecture (ISA)) has been developed primarily for simplicity and scalability. The RISC architecture may provide minimal sets of basic instructions to reduce the complexity of hardware design and maximize efficiency. The RISC architecture may, with its simplicity and modularity, be used in a wide range of applications from embedded systems to high-performance computing devices.

RISC-V, which is a fifth version of the RISC evolved from the RISC, has recently included vector instructions as an essential instruction set. Unlike typical scalar instructions, RISC-V Vector (RVV) instructions may support a vector operation by which multiple pieces of data are processed simultaneously by a single instruction. The vector operation may maximize large-scale data processing performance through parallel processing and may play an especially important role in fields such as high-performance computing, artificial intelligence (AI), machine learning, image processing, and the like.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a computing device includes: one or more processors; and memory storing instructions configured to cause the one or more processors to: receive and decode an instruction stream including instructions and pieces of instruction-information respectively corresponding to the instructions; determine whether the instructions in the instruction stream are translatable into a vector instruction stream based on the pieces of instruction-information; and based on a result of the determining, translate the instructions of the instruction stream to a vector instruction stream, the translating including translating at least some of the instructions of the instruction stream to vector instructions in a vector-specific instruction set by replacing scalar instructions of a first instruction set architecture (ISA) with functionally equivalent vector instructions of a vector-specific ISA.

The determining may include: sequentially determining whether portions of instructions of the instruction stream match a predefined scalar instruction pattern based on pieces of instruction-type information of the portions of the instructions, and based thereon, determining whether the instruction stream matches the scalar instruction pattern.

The determining whether the instructions in the instruction stream are translatable into a vector stream may include: deriving a first address values of portions of the instructions determined to match; and generating a second address value for translation into a vector instruction of the vector instruction stream by integrating the first address values.

The scalar instruction pattern may include at least one of: a first scalar instruction pattern including a backward branch instruction; or a second scalar instruction pattern including a forward branch instruction and a backward unconditional jump instruction.

The determining whether the instructions in the instruction stream are translatable into a vector stream may include: determining, based on source register information and destination register information of the instructions included in the instruction stream, the presence or absence of a register association between the instructions; when there is an absence of an association between the instructions, determining that the instruction stream is not translatable into a vector instruction stream; and when there is a presence of an association between the instructions, determining that the instruction stream is translatable into a vector instruction stream.

The instructions may be further configured to cause the one or more processors to: in response to the second address value, translate the instruction stream into the vector instruction stream.

The instructions may be further configured to cause the one or more processors to: when there is an instruction to be translated to a vector instruction using a register value for the instruction stream, translate the instruction stream into the vector instruction stream using the register value obtained through an access device.

The computing device may further include: a cache memory device configured to store a record of translating the instruction stream into the vector instruction stream, wherein, in the presence of the record stored in the cache memory device, the instruction stream is flushed from a buffer memory and the vector instruction stream is inputted to the buffer memory.

The computing device may further include: a buffer memory; and a decoder, wherein the decoder is configured to: receive the instruction stream from the buffer memory or receive the vector instruction stream from a module that performs the translating, and wherein the instructions are further configured to cause the one or more processors to: receive a second instruction stream including second instructions from the buffer memory, and transfer the translated vector instruction stream to the decoder.

The instruction stream may include a predefined number of instructions.

The computing device may further include: a memory device, wherein the memory device is configured to perform at least one of: storing a new scalar instruction pattern; determining whether the instruction stream is translatable into the vector instruction stream based on the new scalar instruction pattern; or transferring the new scalar instruction pattern to a module that performs the translating.

In another general aspect, a binary instruction translation method includes: receiving and decoding an instruction stream including instructions and pieces of instruction-information respectively corresponding to the instructions; determining whether the instructions in the instruction stream are translatable into a vector instruction stream based on the pieces of instruction-information; and based on a result of the determining, translate the instructions of the instruction stream to a vector instruction stream, the translating including translating at least some of the instructions of the instruction stream to vector instructions in a vector-specific instruction set by replacing scalar instructions of a first instruction set architecture (ISA) with functionally equivalent vector instructions of a vector-specific ISA.

The determining of whether the instruction stream is translatable may include: sequentially determining whether portions of the instruction stream match any of predefined scalar instruction patterns based on indications of opcodes of the respective instructions included in the instruction stream.

The determining of the matching with any of the scalar instruction patterns includes: deriving first address values for each portion that matches one of the scalar instruction patterns; and generating a second address value for translation into a vector instruction of the vector instruction stream by integrating the first address values.

The scalar instruction pattern may include: a first scalar instruction pattern including an indication of a backward branch instruction; and a second scalar instruction pattern including an indication of a forward branch instruction and a backward unconditional jump instruction.

The determining of whether the instruction stream is translatable may include: determining, based on source register information and destination register information of the instructions included in the instruction stream, the presence or absence of a register association between a pair of the instructions; when determined that there is an absence of an association, determining the instruction stream to be not translatable into a vector instruction stream; and when determined that there is a presence of an association, determining the instruction stream to be translatable into a vector instruction stream.

The translating the instruction stream into the vector instruction stream may be based on the second address value.

When there is an instruction to be translated using a register value for the instruction stream, translating the instruction stream into the vector instruction stream may include using the register value, and the register value may be obtained through an access device.

Based on the presence, in a translation trace cache (TTC) memory, of a record of translating the instruction stream into the vector instruction stream: the instruction stream may be flushed from a buffer memory; and the vector instruction stream may be inputted to the buffer memory.

The binary instruction translation method may further include: transferring the instruction stream to an external memory based on the determining, and determining whether the instruction stream matches a new scalar instruction pattern newly stored in the memory; or loading the new scalar instruction pattern into a device that performs the translating from the memory storing the new scalar instruction pattern.

Other features and aspects will be apparent from the following detailed description, the drawings, and the claims.

### BRIEF DESCRIPTION OF THE DRAWINGS

FIG. 1 illustrates an example of a core pipeline including a compiler device according to one or more embodiments.

FIG. 2 illustrates an example of an operational configuration of a compiler device according to one or more embodiments.

FIGS. 3A and 3B illustrate examples of translation into a vector instruction stream according to one or more embodiments.

FIG. 4 illustrates an example of an operational method of an input module according to one or more embodiments.

FIG. 5 illustrates an example of an operational method of a determination module according to one or more embodiments.

FIGS. 6A and 6B illustrate example types of predefined scalar instruction patterns according to one or more embodiments.

FIGS. 7, and 8A and 8B illustrate an example of a method of implementing an instruction compare logic (ICL) module according to one or more embodiments.

FIG. 9 illustrates an example of a scratchpad memory added to a compiler device according to one or more embodiments.

FIGS. 10A, 10B, 10C, and 11 illustrate examples of a multi-stream sequential comparison (MSSC) method according to one or more embodiments.

FIG. 12 illustrates an example of an output module according to one or more embodiments.

FIG. 13 illustrates an example structure of a translation trace cache (TTC) according to one or more embodiments.

FIG. 14 illustrates an example flow of operations performed by a computing device according to one or more embodiments.

Throughout the drawings and the detailed description, unless otherwise described or provided, the same or like drawing reference numerals may be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

As used in connection with certain example embodiments of the disclosure, the term “module” may include a unit implemented in hardware, software, or firmware, or any combination thereof, and may interchangeably be used with other terms, for example, “unit,” “logic,” “logic block,” “part,” or “circuitry.” A module may be a single integral component, or a minimum unit or part thereof, adapted to perform one or more functions. A module may be mechanically or electronically implemented. For example, a module may include at least one of an application-specific integrated circuit (ASIC), a field-programmable gate array (FPGA), or a programmable-logic device (PLD) to perform operations that have been known or to be developed.

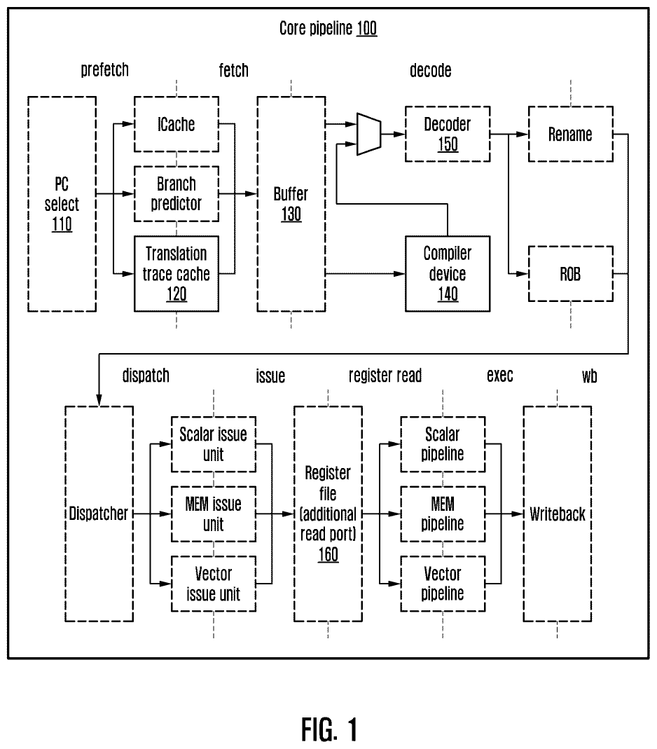

FIG. 1 illustrates an example of a core pipeline 100 including a compiler device 140 according to one or more embodiments.

In the example of FIG. 1, one or more blocks and combinations of the blocks may be implemented by a processor, a hardware accelerator, a computer based on special-purpose hardware that performs a specific function, and/or a combination of special-purpose hardware, and may be driven by computer instructions.

The core pipeline 100 illustrated in FIG. 1 is a non-limiting example; other types of core pipelines that support vector operations using a vector register and a vector operation unit may also be applied as the core pipeline 100. Although the core pipeline 100 is illustrated in FIG. 1 as an out-of-order core pipeline, examples are not necessarily limited thereto.

Referring to FIG. 1, according to an embodiment, the core pipeline 100 may be a nine-stage computational pipeline including nine stages of operations: instruction prefetch, instruction fetch, instruction decode, instruction dispatch, issue, register read, execution, memory access, and writeback.

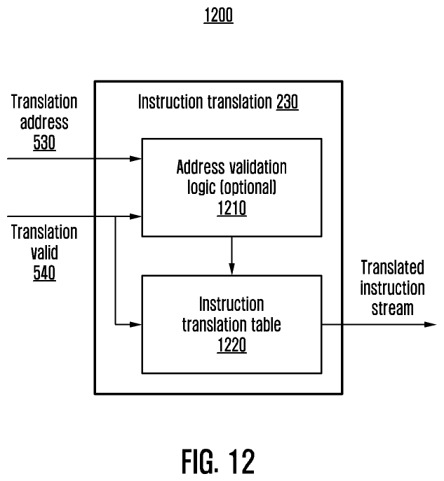

According to an embodiment, in the “instruction prefetch”—“instruction fetch” stage, a program counter (PC) select module (or PC select module) 110 may use an instruction cache (I-Cache), a branch predictor, or a combination thereof to fetch instruction streams based on a current PC value and determine instruction streams that are to be input to a buffer memory 130. Depending on embodiments, the PC select module 110 may further use a translation trace cache (TTC) 120. The PC select module 110 may also update the PC value based on address values of the instruction streams input to the buffer memory 130. The operations of the TTC 120 are described below with reference to FIG. 12.

In the “instruction decode” stage, the instruction streams input to the buffer memory 130 may be input to a decoder 150. According to an embodiment, while monitoring the instruction streams input to the buffer memory 130, the compiler device 140 may determine which instruction streams are translatable into vector instruction streams and translate them based on a result of the determination.

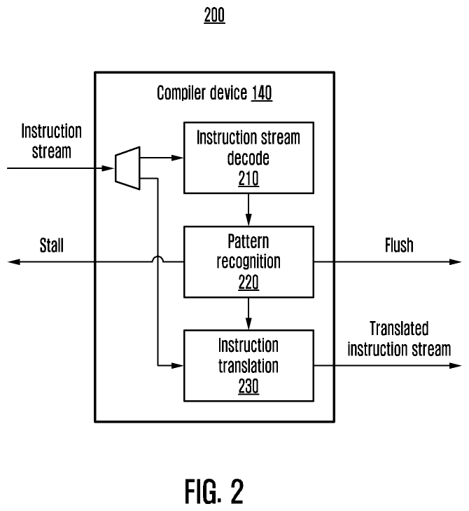

The compiler device 140 may transfer, to the decoder 150, at least one instruction stream determined to be translatable into a vector instruction stream among the instruction streams input to the buffer memory 130. The operations of the compiler device 140 are described below reference to FIGS. 2 through 12.

In the core pipeline 100 illustrated in FIG. 1, blocks included in subsequent stages after the instruction decode stage may all be provided as an example, and examples are not necessarily limited thereto.

According to some embodiments, provided is a technology that efficiently utilizes vector hardware, even when software designed without sufficient consideration of vector operations is run, thereby preventing performance degradation and resource waste.

For example, even when a binary program compiled only with scalar operations, without typical vector operations assumed, is executed in the core pipeline 100, using the compiler device 140 may allow the vector operations to be performed in a hardware manner to provide high-speed computational results without requiring additional actions from a user, such as, for example, an action of installing separate software or recoding, and may thus ensure software transparency or binary compatibility.

In addition, the core pipeline 100 may include an access device having direct access to values in a register file 160, depending on implementations. According to an embodiment, the access device may include a register read port dedicated to compiler devices or a separate buffer memory configured to update and store, in real time, register values to be referred to. In this case, including the access device may allow the compiler device 140 to quickly fetch values stored in a register, enabling high-speed vector instruction stream translation.

According to some embodiments, a computing device, which includes the core pipeline 100 or at least one of the blocks and the combinations of the blocks included in the core pipeline 100, may be at least one of a special-purpose hardware-based computer performing specific functions, a general-purpose hardware-based computer performing general-purpose functions, or a computing device including general-purpose hardware.

FIG. 2 illustrates an example of an operational configuration 200 of the compiler device 140 according to one or more embodiments.

Referring to FIG. 2, according to an embodiment, the compiler device 140 may include an input module 210 (e.g., an instruction stream decode (ISD) module), a determination module 220 (e.g., a pattern recognition module), and an output module 230 (e.g., an instruction translation module).

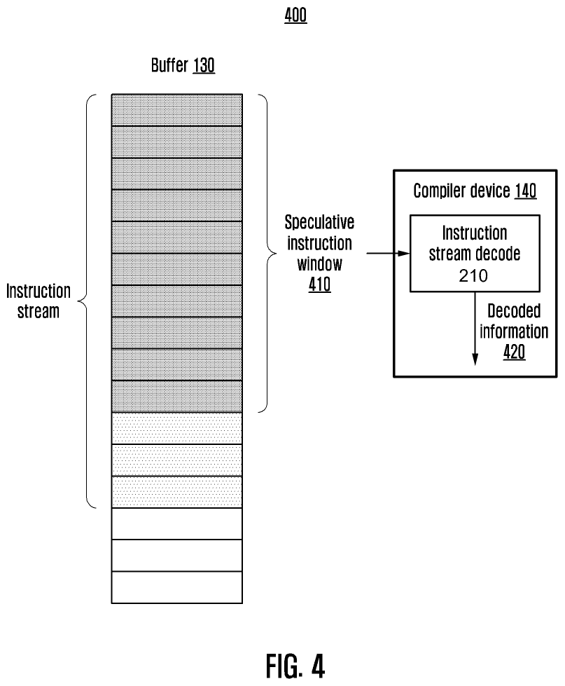

According to an embodiment, the input module 210 may decode each instruction included in an instruction stream received from the buffer memory 130 and obtain information associated with each instruction. The input module 210 may transfer the information obtained through the decoding to the determination module 220. The operations of the input module 210 are described below with reference to FIG. 4.

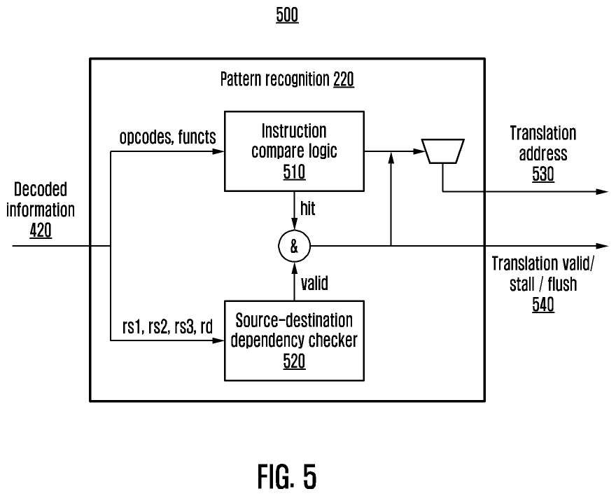

According to an embodiment, based on the information received from the input module 210, the determination module 220 may determine whether an instruction stream input from the buffer memory 130 is translatable into a vector instruction stream. The determination module 220 may transfer, to the output module 230, information associated with an instruction stream that it has determined to be translatable. The operations of the determination module 220 are described below with reference to FIGS. 5 through 11.

According to an embodiment, the output module 230 may translate, into a vector instruction stream, the instruction stream determined to be translatable by the determination module 220. The output module 230 may transfer the vector instruction stream to the decoder 150. The operations of the output module 230 are described below with reference to FIG. 12.

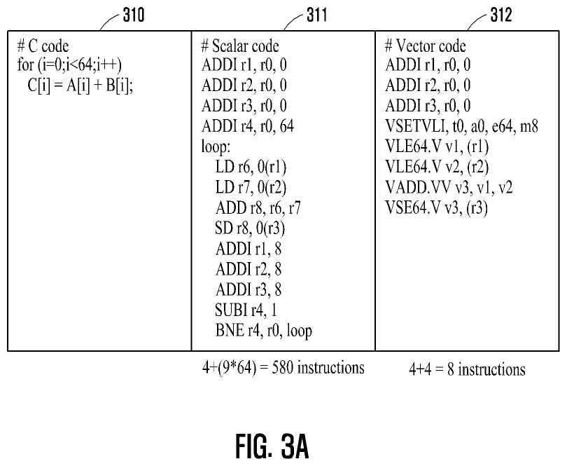

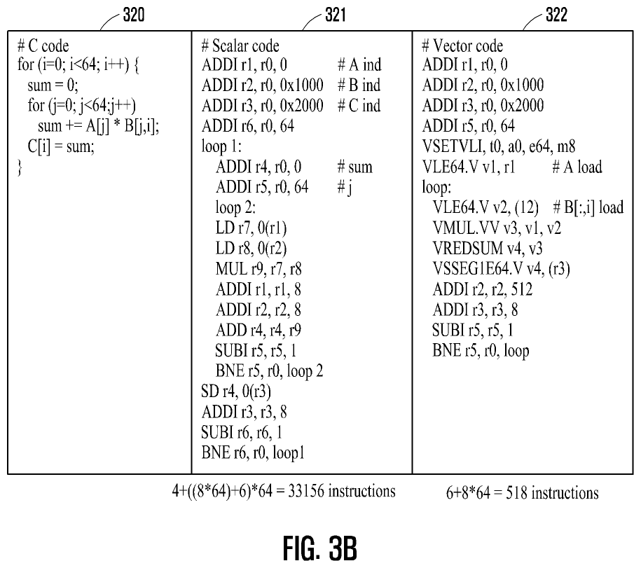

FIGS. 3A and 3B illustrate examples of translation into a vector instruction stream according to one or more embodiments.

Referring to FIG. 3A, a translation of scalar-based instructions into a vector instruction stream may allow the functionality of the scalar-based instructions to be performed with the execution of fewer instructions, by performing a hardware-based vector-vector operation.

According to an embodiment, when a program is to be executed on an information processing device such as a computer, C code may be translated into a language to be understood by the information processing device, i.e., a series of instructions compliant with an instruction set architecture (ISA) implemented in a processor of the information processing device.

For example, FIG. 3A illustrates a program 310 in which a vector add operation with 64 elements is written in C code. FIG. 3A also illustrates case 311 where the C code is translated to a scalar instruction stream for a RISC-V ISA that does not include a RISC-V vector extension (RVV Extension).

FIG. 3A also illustrates case 312 where the program 310 (more specifically, the scalar instructions of case 311) is translated to instructions of the RISC-V ISA that includes the RVV Extension, generating a vector instruction stream that includes instructions of the RVV Extension. An instruction stream generated by being translated to the RISC-V ISA may vary depending on the versions or options of a compiler.

The case 311 of the translation into a scalar instruction stream may require a total of 580 instructions, while the case 312 of the translation into a vector instruction stream may require a total of 8 instructions for the same task. For example, a single vector instruction (e.g., VADD.VV) may be used to perform an add operation (ADD) on 64 elements.

In a case where instructions of a program compiled only with a scalar instruction stream are being executed, although translation of the scalar instruction stream into a vector instruction stream may consume a certain amount of time (e.g., approximately a few tens of cycles), the use of a vector processing unit of an electronic device to execute the vectorized program instructions may enable faster overall computational processing. In addition, the translation into a vector instruction stream may shorten a process spanning from the “instruction fetch” stage to the “instruction execution” stage (inclusive), allowing a central processing unit (CPU) to be driven more efficiently in terms of energy consumption.

Referring to FIG. 3B, scalar-to-vector translation may allow a vector-matrix multiply operation to be performed with fewer instructions, compared to a typical method of executing the scalar instructions as such. Therefore, the translation into a vector instruction stream may be more effective as the size or dimensionality of data to be computed increases.

For example, FIG. 3B illustrates a C code program 320 that performs a vector multiply-and-accumulate operation, with 64 elements. FIG. 3B also illustrates case 321 where the C code program 320 is translated to scalar instructions of a RISC-V ISA that does not include an RVV Extension that supports vector operations. FIG. 3B also illustrates case 322 where the C code program 320 (more specifically, the scalar instructions of case 311) is translated to instructions of a RISC-V ISA including the RVV Extension, thereby generating a vector instruction stream that newly includes instructions of the RVV Extension.

The case 321 of the translation into a scalar instruction stream may require a total of 33156 instructions, while the case 322 of the translation into a vector instruction stream may require a total of 518 instructions for the same task (not including instructions to perform the translating to vector instructions). Translating a scalar instruction stream into a vector instruction stream may itself consume a certain amount of time (or cycles) but may nonetheless enable faster overall computational processing and save a great amount of energy, which may significantly compensate for the amount of time (or cycles) consumed for the translation from scalar instructions to vector instructions.

FIG. 4 illustrates an example of an operational method 400 of the input module 210 according to one or more embodiments.

According to an embodiment, the input module 210 (e.g., decoder) may receive, as an input, some or all of input instruction streams stored in the buffer memory 130. In this case, the input module 210 may receive an instruction stream including a predefined number of instructions (the predefined number is discussed shortly). The input module 210 may decode each instruction included in the input instruction stream and transfer information 420 corresponding to each instruction to the determination module 220 (see FIG. 5).

The information 420 corresponding to each instruction may include instruction-type information, register information, and the like. For example, the instruction-type information may include an operation code (Opcode), a function field (functs), and the like, and the register information may include source register information (rs), destination register information (rd), or allocated register information (r), and the like.

The predefined number may be a range of receivable inputs based on a range of a determination target instruction window (also a “speculative instruction window” 410 herein). In general, the size of the speculative instruction window 410 may be configured to be greater than or equal to the number of instructions to be fetched (or “fetch width”) from the buffer memory 130 to the decoder 150. By configuring the size of the speculative instruction window 410 to be greater than or equal to the fetch width, the compiler device 140 may track and process more instructions, enabling efficient scalar-to-vector instruction stream translation.

An instruction stream that is translatable in the compiler device 140 may be a series of scalar instructions bundled in the form of a loop. That is, instructions having a structure in which multiple operations are executed in a loop may be a target to be translated into vector instructions. However, when the length of an instruction stream processible by a vector operation exceeds a certain size, loop unrolling may not generally occur due to the full scope of the loop not being visible (e.g., within the fetch window).

Accordingly, in a non-limiting example, a generally required size of the speculative instruction window 410 may correspond to at least five to six instructions, or more, which is the size of a typical basic block, i.e., a block of instructions that are bundled by a branch instruction. The basic block may be a set of instructions that are executed consecutively, which may refer to a series of instructions that are executed until the branch instruction occurs.

Translation into a vector instruction stream by the compiler device 140 may involve approximately dozens of cycles, for example. Therefore, setting the size of the speculative instruction window 410 to be greater may allow more instructions to be processed at once, and thus a stall cycle that may occur during translation may be reduced. The stall cycle is the time by which processing speed is delayed due to a stall in instruction processing caused by the translation.

FIG. 5 illustrates an example of an operational method 500 of the determination module 220 according to one or more embodiments.

The determination module 220 may include an instruction compare logic (ICL) module 510 and a source-destination dependency checker (SDDC) module 520, and may also include other logic modules.

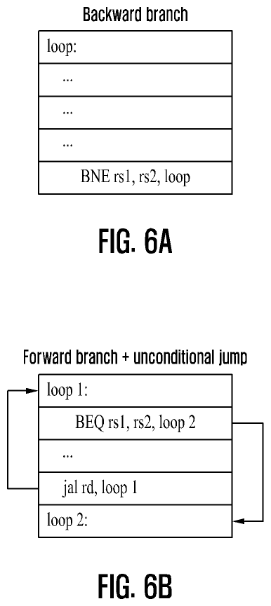

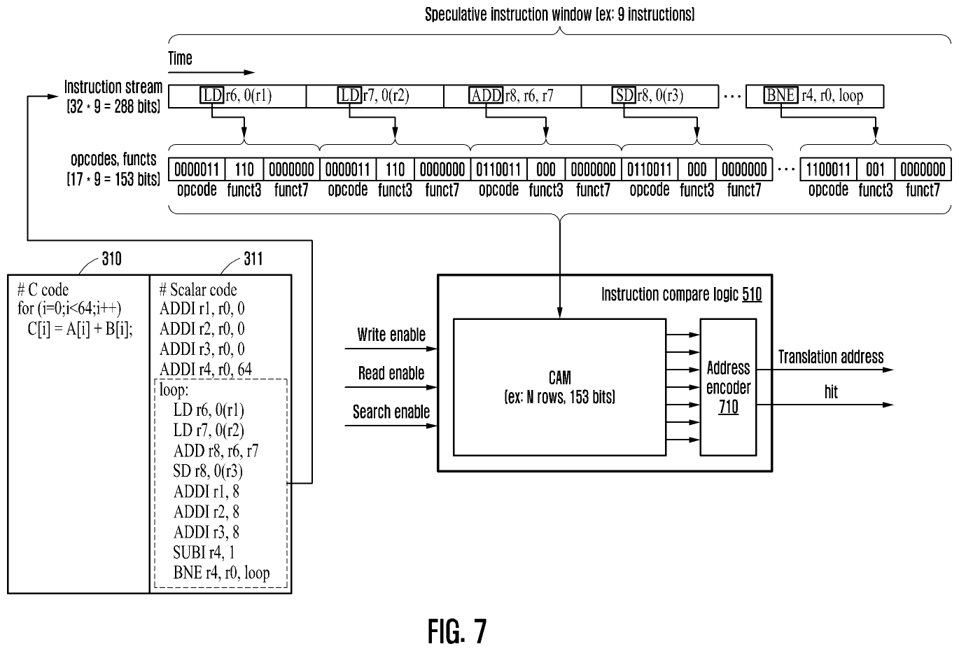

In response to each of one or more scalar instruction streams input to the input module 210, the ICL module 510 may determine whether a scalar instruction stream matches at least a portion of a predefined scalar instruction pattern, based on instruction-type information of the information 420 received from the input module 210. Based on a result of determining the pattern-matching of each of the one or more scalar instruction streams, the ICL module 510 may determine whether the scalar instruction stream matches the scalar instruction pattern. The scalar instruction pattern is described below with reference to FIGS. 6A and B, and a method for implementing the ICL module 510 is described with reference to FIGS. 7 through 13.

Based on source register information and destination register information of instructions included in the instruction stream (e.g., parameter and output registers), in the information 420 received from the input module 210, the SDDC module 520 may determine the presence or absence of register associations between the instructions (e.g., registers shared by the instructions, have a functional relationship, etc.). The SDDC module 520 may determine whether source registers and destination registers of the instructions are properly associated and arranged according to the sequence of the instructions to determine whether the instruction stream is translatable into a vector instruction stream.

In a case where the registers are not properly associated and arranged according to the sequence of the instructions, even when the ICL module 510 determines that the translation into a vector instruction stream is otherwise available, translation into a vector instruction stream may not be available, and thus results from both the ICL module 510 and the SDDC module 520 may be verified as valid before performing translation.

When it is determined both the ICL module 510 and the SDDC module 520 that translation into a vector instruction stream is available/possible, the determination module 220 may provide, to the output module 230, (i) a signal 540 for invoking translation along with (ii) an address value 530 for the translation into a vector instruction stream obtained from the ICL module 510. The determination module 220 may also output a stall signal in the “instruction fetch” stage of the core pipeline 100 and, when a scalar instruction stream, which is a target to be translated, is already executed, may output a flush signal in a subsequent stage after the “instruction decode” stage, thereby ensuring that a translatable scalar instruction stream is not executed in a scalar operation pipeline (since it will instead be executed in its vector-translated form).

FIGS. 6A and 6B illustrate example types of predefined scalar instruction patterns according to one or more embodiments.

A predefined scalar instruction pattern may be an instruction pattern that is basically configured in the form of a loop. There may be multiple redefined scalar instruction patterns, for instance a first scalar instruction pattern and a second scalar instruction pattern.

The first scalar instruction pattern may abstractly describe a backward branch instruction, in which several instructions are executed and then a conditional backward branch instruction (returning to a previous PC value of a current PC value) is executed at the end of the loop.

For example, FIG. 6A illustrates an example of the first scalar instruction pattern in which, when a branch-not-equal (BNE) instruction is executed, in response to a value matching rs1 being determined to be different from a value matching rs2, the instruction is returned to a position in the loop and executed again.

The second scalar instruction pattern may abstractly describe a forward branch instruction and an unconditional jump instruction, in which a foremost conditional forward branch instruction (jumping to a subsequent PC value of a current PC value) is executed and is then returned to the branch instruction by the unconditional jump instruction at the end of the loop.

For example, FIG. 6B illustrates an example of the second vector instruction stream pattern in which, when a branch-if-equal (BEQ) instruction is executed, the instruction is executed at a position in loop 2 in response to a value of rs1 and a value of rs2 being equal to each other, and an instruction in a line following the BEQ instruction is executed in response to the value of rs1 and the value of rs2 being different from each other.

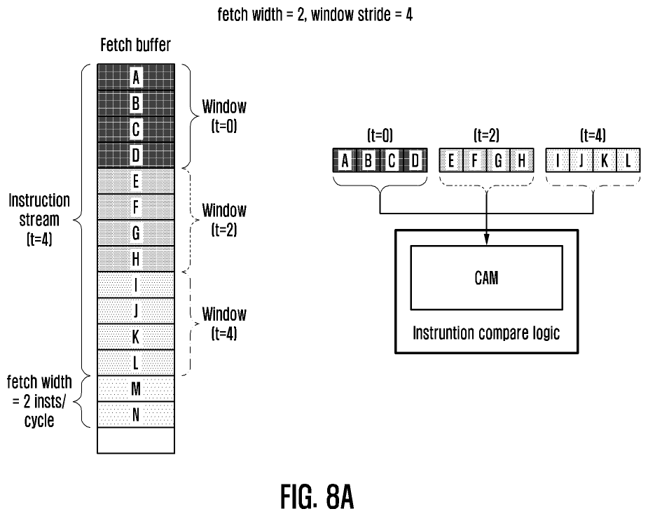

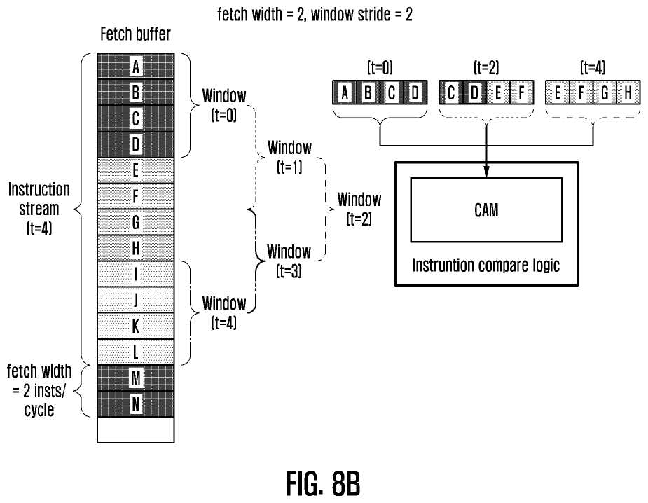

FIGS. 7, and 8A and 8B illustrate an example of a method of implementing an ICL module according to one or more embodiments.

The ICL module 510 may be implemented by various methods including, for example, a method using a content-addressable-memory (CAM), a method using a finite-state machine (FSM), and a method with sequential logic. A CAM is generally a memory structure that simultaneously performs comparisons between input data and data stored in a table, enabling fast searches and comparisons.

Source code is compiled into an input instruction stream which may have slightly different instruction patterns depending on compiler types and compilation options, and there may thus be various lengths, orders, and types of patterns to be compared. Accordingly, because new patterns to be compared and corresponding vector instruction streams may be added by expanding tables for the comparison, implementing the ICL module 510 using the CAM may be effective in terms of scalability.

FIG. 7 illustrates a case where a scalar instruction stream included in the case 311 of FIG. 3A is performed by setting the size of the speculative instruction window 410 to the size of 9 instructions. In this case, the size of the speculative instruction window 410 may allow the ICL module 510 to quickly compare, using a CAM having a comparison table including multiple rows and columns, a pattern in the table and at least one instruction stream, based on instruction-type information received from the input module 210. When a matching pattern is found through the CAM, the CAM of the ICL module 510 may output a hit signal, and an address encoder 710 of the ICL module 510 may generate an address value for translation.

The at least one instruction stream to be compared through the CAM may vary depending on various sizes of the speculative instruction window 410 and strides of the speculative instruction window 410.

For example, FIG. 8A illustrates a case where the size and the stride of the speculative instruction window 410 are 4 and 4, respectively, and two instructions are input to the buffer memory 130 every cycle. That is, in this case, four instructions may be stacked in the buffer memory 130 every two cycles and observed through the speculative instruction window 410. Every two cycles (t=0, t=2, t=4, . . . ), a new block (e.g., ABCD, EFGH, IJKL, . . . ) of four non-overlapping instructions may be transferred to the CAM for comparison. The instructions may be grouped based on a certain cycle (e.g., four instructions every two cycles), and pattern matching may be performed.

In addition, FIG. 8B illustrates a case where the size and the stride of the speculative instruction window 410 are 4 and 2, respectively, and two instructions are input to the buffer memory 130 every cycle. In this case, the speculative instruction window 410 may be shifted by two instructions every cycle, and consecutive instruction blocks may be overlapped and compared. For example, in the first cycle (t=0), ABCD, which are four instructions stacked in the buffer memory 130, may be transferred to the CAM. In the second cycle (t=1), CDEF may be transferred to the CAM, and in the third cycle (t=2), EFGH may be transferred to the CAM. These overlapped instruction groups may be iteratively transferred to the CAM for comparison.

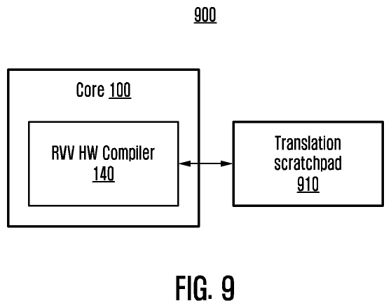

FIG. 9 illustrates an example 900 of a scratchpad memory added to a compiler device according to one or more embodiments.

According to an embodiment, a memory-mapped, non-cacheable scratchpad memory 910 dedicated to the compiler device 140 may be separately installed inside or outside the core pipeline 100. The separate installation of the scratchpad memory 910 may overcome limitations associated with expanding the size of the CAM (within the determination module 220) to add a new pattern.

When a user desires translation into a vector instruction stream through a new scalar instruction pattern, using the compiler device 140, the user may input and store values in a predefined form into the scratchpad memory 910. In a case where the scratchpad memory 910 resides outside the compiler device 140, the compiler device 140 may, in response to a failure in matching with a scalar instruction pattern in the compiler device 140, transfer the pattern to the outside of the scratchpad memory 910 for additional matching determination.

Additionally, the user may write, in advance, some types of translation tables associated with the new scalar instruction pattern in the scratchpad memory 910 and may then configure a scratchpad memory such that it replaces or loads comparison patterns of the CAM performed by the ICL module 510 depending on a specific application. In this case, installing the scratchpad memory may further improve the performance of the compiler device 140 in translating a scalar instruction stream into a vector instruction stream.

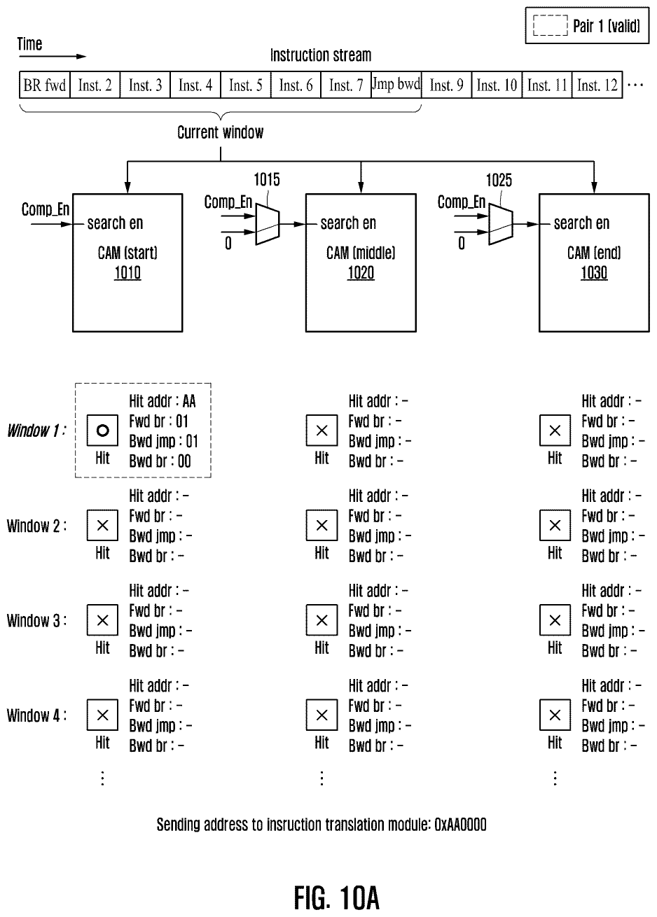

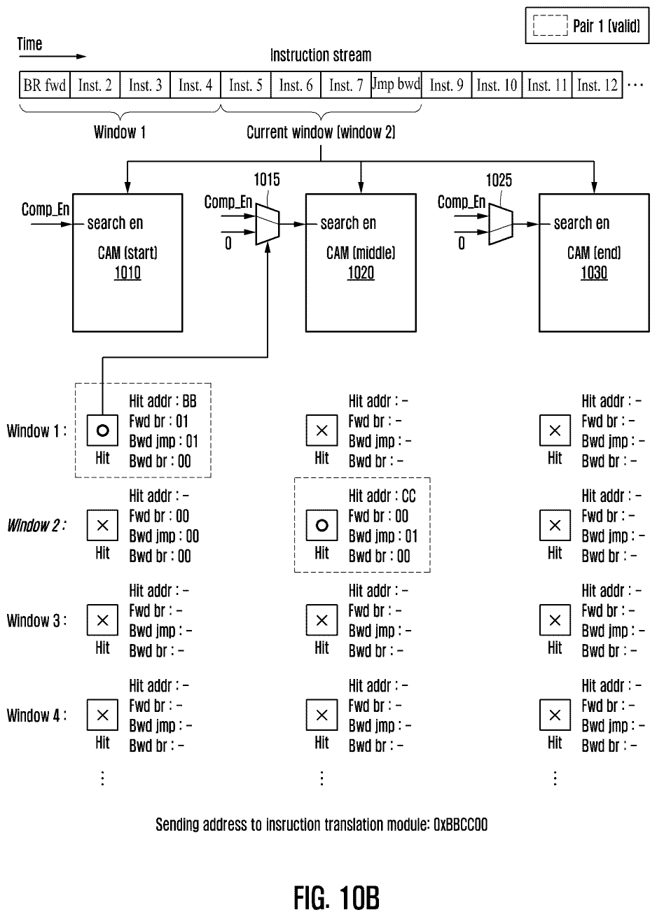

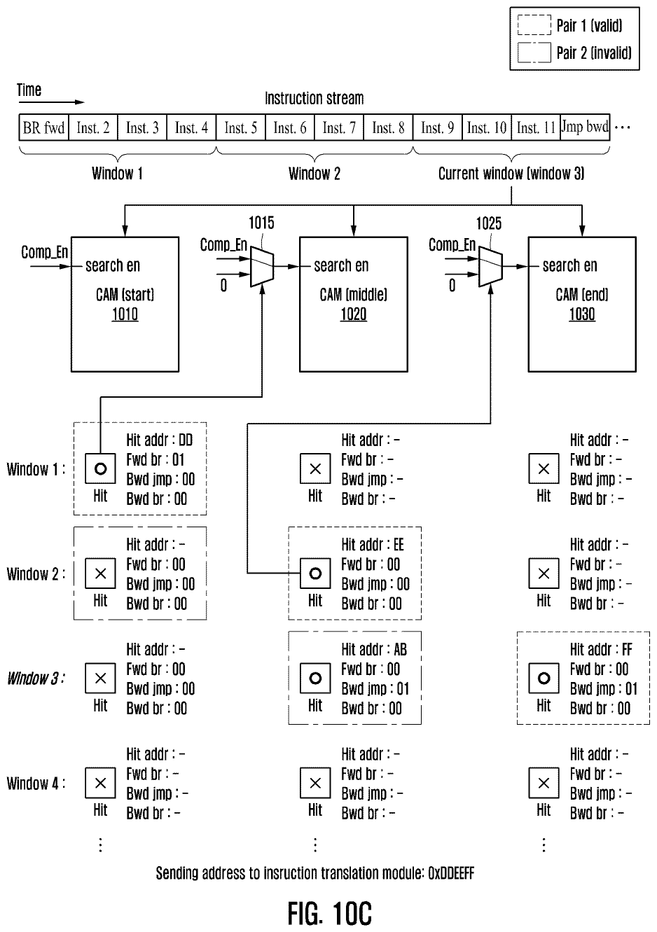

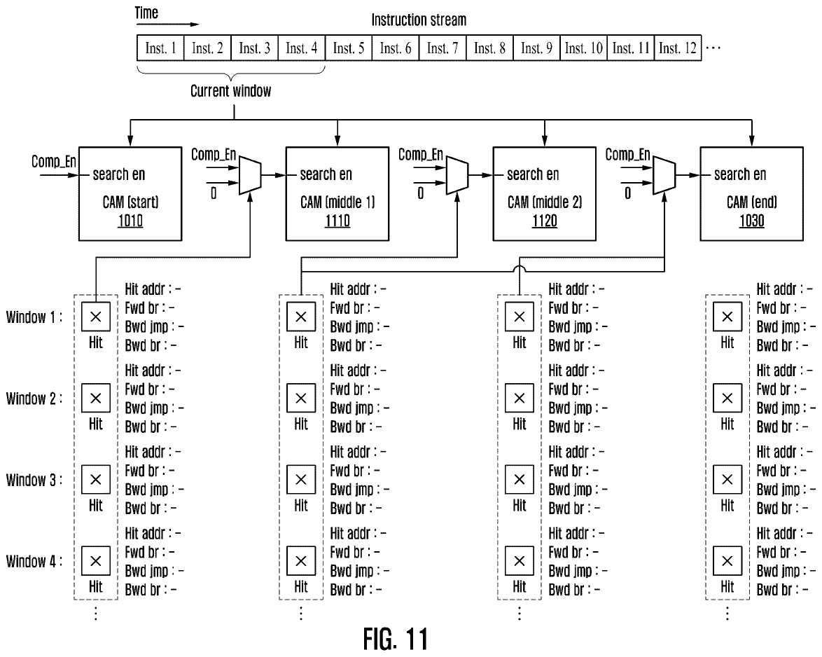

FIGS. 10A through 10C, and 11 illustrate examples of a multi-stream sequential comparison (MSSC) method according to one or more embodiments.

When implemented with a CAM, while the ICL module 510 may set various lengths for input instructions to be compared against patterns, the speculative instruction window 410 may have a limited size (e.g., a hardware resource limit). When a translatable instruction stream falls within the size of the speculative instruction window 410, pattern matching may be performed relatively easily with only one speculative instruction window 410. However, in general, it may be more likely that a translatable instruction stream (e.g., a translatable portion of the instruction stream) may pass throughout multiple speculative instruction windows 410, rather than through a single speculative instruction window 410.

Thus, when implementing the ICL module 510, the ICL module 510 may be implemented using the MSSC method, thereby facilitating translation of an instruction stream into a vector instruction stream.

The ICL module 510 implemented using the MSSC method may, at each cycle, simultaneously input an instruction stream that is in the single speculative instruction window 410, into multiple CAMs having different patterns, rather than varying the length of the input instruction stream, and may then store per-CAM comparison results in registers. In this case, when valid patterns are output sequentially from the registers, the ICL module 510 may transmit such a result to a subsequent module.

The CAMs in the ICL module 510 implemented through the MSSC method may be configured as three types: a start CAM 1010, a middle CAM 1020 (there may be multiple middle CAMs), and an end CAM 1030. Each of the CAMs may sequentially correspond to at least a portion of predefined scalar instruction patterns.

The CAMs used in the MSSC method may have a certain number of hit registers (see FIG. 10A). For example, each CAM may have a respectively corresponding hit register. In this case, as described in greater detail below, a given hit register may sequentially indicate detections/matches for respective windows (see “Window 1” . . . “Window 4” in FIG. 10A), for an instruction stream corresponding to at least one speculative instruction window 410 against which each CAM is compared, whether the instruction stream matches at least a portion of scalar instruction patterns of the CAM corresponding to the given register. In this way, for example, when the start CAM 1010 registers a hit, comparison of the same instructions to the subsequent CAMS may be avoided.

The detection of matching with at least a portion of scalar instruction patterns of each CAM may be performed based on instruction-type information received from the input module 210. Further, the matching between at least a portion of the scalar instruction patterns and an instruction stream corresponding to at least one speculative instruction window 410 may be determined sequentially (from one CAM to the next) through an “enable configuration” that may allow individual enabling of each CAM (see “Comp_En” in FIG. 10A, “Comp” being short for “Compare”).

A hit register may output a hit signal in response to the matching of a scalar instruction pattern in the hit register's corresponding CAM. Based on the hit signal of the corresponding CAM, the CAM may transfer a first address value therewithin to the address encoder 710 of the ICL module 510 (this functionality may be present in each CAM). The address encoder 710 may integrate first address values received from the respective CAMs to generate a second address value for translation into a vector instruction stream.

FIG. 10A illustrates an example of a case where an instruction stream (top of FIG. 10A) including a forward branch instruction and an unconditional jump instruction corresponds to one speculative instruction window 410. In this case, a predefined scalar instruction pattern and the instruction stream corresponding to the one speculative instruction window 410 may be matched.

In this case, matching with the scalar instruction pattern may be performed through a search for the one speculative instruction window 410, without passing through multiple speculative instruction windows 410, and thus the matching with the scalar instruction pattern may be performed only with the start CAM 1010. Thus, in FIG. 10A, since matching in the start CAM 1010 means that other CAMs will not also match the speculative instruction window, the start CAM 1010 may not transfer an “enable” signal (“Comp_En”) to the middle CAM 1020, and thus the middle CAM 1020 and the end CAM 1030 may be disabled by inputting zero (0) to their enable-switches 1015 and 1025, respectively (which may be configured with AND logic).

Because, in the example of FIG. 10A, matching with a scalar instruction pattern has occurred only in the start CAM 1010, a hit register corresponding to that pattern/CAM may output a hit signal and the corresponding start CAM 1010 may, based on the hit signal, transfer, to the address encoder 710 of the ICL module 510, an address value at the start CAM 1010 (which is “AA” in FIG. 10A, i.e., the aforementioned first address value). The address encoder 710 may receive the first address value (e.g., AA) from the start CAM 1010 and based thereon may generate a final address value (which is 0xAA0000 in hexadecimal in FIG. 10A, i.e., the aforementioned second address value) for translation into a vector instruction stream.

FIG. 10B illustrates an example of a case where an instruction stream including a forward branch instruction and an unconditional jump instruction corresponds to two speculative instruction windows 410. That is, in this case, the potentially-translatable instruction stream may be input throughout multiple speculative instruction windows 410 instead of a single speculative instruction window 410.

For example, the start CAM 1010 may perform matching between (i) at least one scalar instruction pattern thereof (or possibly a portion thereof) and (ii) instructions corresponding to at least one speculative instruction window 410. In this case, the one of the scalar instruction patterns of the start CAM 1010 may be a pattern of a forward branch instruction. Since, in the start CAM 1010, the one scalar instruction pattern and the instructions corresponding to the first speculative instruction window 410 are matched, a hit register corresponding to that one pattern may output a hit signal and based thereon the hit register's CAM (start CAM 1010) may transfer, to the address encoder 710 of the ICL module 510, an address value (e.g., “BB” in FIG. 10B).

For example, when the one matched scalar instruction pattern and the instructions corresponding to the first speculative instruction window 410 are matched, the start CAM 1010 may transfer an “enable” signal (e.g., Comp_En) to the “enable” enable-switch 1015 of the middle CAM 1020 to enable the middle CAM 1020.

Since the middle CAM 1020 is enabled, the middle CAM 1020 may perform matching between (i) at least one scalar instruction pattern thereof (or possibly a portion thereof) and (ii) instructions corresponding to each of the at least one speculative instruction window 410. In this case, the one scalar instruction pattern may be a pattern including an unconditional jump instruction. Since, in the middle CAM 1020, the one scalar instruction pattern and the instructions corresponding to a second speculative instruction window 410 are matched, a hit register corresponding to that one pattern may output a hit signal and based thereon the hit register's middle CAM 1020 may transfer, to the address encoder 710 of the ICL module 510, an address value (e.g., “CC” in FIG. 10B).

In this case, since the instructions corresponding to the scalar instruction patterns have been detected by both the start CAM 1010 and the middle CAM 1020, the middle CAM 1020 may not transfer an “enable” signal to the end CAM 1020, thus disabling the end CAM 1030.

The address encoder 710 may receive the address value BB and the address value CC from the start CAM 1010 and the middle CAM 1020, respectively, to generate a final address value (e.g., 0xBBCC00 in hexadecimal in FIG. 10B) for translation into a vector instruction stream.

FIG. 10C illustrates an example of a case where an instruction stream including a forward branch instruction and an unconditional jump instruction corresponds to three speculative instruction windows 410.

In the example of FIG. 10C, the start CAM 1010 may perform matching between at least one scalar instruction pattern (or a portion thereof) and instructions stream to at least one speculative instruction window 410. In this case, the one scalar instruction pattern may be a pattern including a forward branch instruction. In the start CAM 1010, the one scalar instruction pattern and instructions corresponding to a first speculative instruction window 410 matched, and consequently a hit register corresponding to that pattern may output a hit signal and based thereon the start CAM 1010 may transfer, to the address encoder 710 of the ICL module 510, an address value (e.g., “DD” in FIG. 10B) at the start CAM 1010.

In addition, when the start CAM 1010 matches the scalar instruction pattern with the instructions corresponding to the speculative instruction window 410, the start CAM 1010 may transfer an “enable” signal to the “enable-switch 1015 of the middle CAM 1020 to enable the middle CAM 1020.

As the middle CAM 1020 is enabled, the middle CAM 1020 may perform matching between a scalar instruction pattern (or portion thereof) and instructions corresponding to each speculative instruction window 410. In this case, the scalar instruction pattern may be a pattern that does not include a forward branch instruction and an unconditional jump instruction. Since, in the middle CAM 1020, the scalar instruction pattern and the instructions corresponding to a second speculative instruction window 410 match, a hit register corresponding to that pattern may output a hit signal and based thereon the middle CAM 1020 may transfer, to the address encoder 710 of the ICL module 510, an address value (e.g., “EE” in FIG. 10B) at the middle CAM 1020.

In this case, a scalar instruction pattern (or portion thereof) and instructions corresponding to a third speculative instruction window 410 may be matched in the middle CAM 1020. However, for the instructions corresponding to the second speculative instruction window 410, which is a window immediately preceding the third speculative instruction window 410, the instructions may not be matched to the scalar instruction pattern in the start CAM 1010, and therefore the ICL module 510 implemented by the MSSC method (of sequentially determining matching for respective CAMs) may determine this to be invalid pattern matching.

When, in the middle CAM 1020, the scalar instruction pattern thereof and the instructions corresponding to the speculative instruction window 410 are matched, the middle CAM 1020 may transfer an “enable” signal to the enable configuration 1025 of the end CAM 1030 to enable the end CAM 1030.

When the end CAM 1030 is enabled, the end CAM 1030 may perform matching between a scalar instruction pattern (or portion thereof) and instructions corresponding to each speculative instruction window 410. In this case, the scalar instruction pattern may include an unconditional jump instruction. Since, in the end CAM 1030, the at least a portion of the scalar instruction pattern and the instruction stream corresponding to the third speculative instruction window 410 are matched, a hit register corresponding to that pattern may output a hit signal and based thereon the end CAM 1030 may transfer, to the address encoder 710 of the ICL module 510, an address value (e.g., “FF” in FIG. 10B) at the end CAM 1030.

The address encoder 710 may receive the address value DD, the address value EE, and the address value FF from the start CAM 1010, the middle CAM 1020, and the end CAM 1030, respectively, to generate a final address value (e.g., 0xDDEEFF in hexadecimal in FIG. 10C) for translation into a vector instruction stream.

Referring to the example of FIG. 11, the ICL module 510 may include multiple middle CAMs 1110 and 1120, a start CAM 1010, and an end CAM 1030. For the description of the example of FIG. 11, reference may be made to what has been described above with reference to FIGS. 10A through 10C.

FIG. 12 illustrates an example 1200 of the output module 230 according to one or more embodiments.

The output module 230 may include, but is not necessarily limited to, an address validation logic (AVL) module 1210 and an instruction translation table (ITT) module 1220, and may also include other logic modules.

The AVL module 1210 may be implemented, as needed, if additional validation is required for an address value 530 for translation, which is an output of the determination module 220. For example, in a case where the same instruction stream has duplicate different pattern detection results (e.g., address values for translation), or in a case where there is a combination of invalid address values, the AVL module 1210 may prevent the translation of an instruction stream into a vector instruction stream from being performed.

The ITT module 1220 may translate an instruction stream into a corresponding vector instruction stream based on the input address value 530 for translation, which is received by the output module 230. In a case where there are instructions associated with an instruction (e.g., vsetvli) for configuring a vector size and the like and an instruction (e.g., ld, st) that refers to a register value, the ITT module 1220 may include a logic module that reads a value from a register file, without writing some of values stored in a table of the ITT module 1220, or that generates an instruction by a separate operation unit (e.g., an arithmetic logic unit (ALU)) and the like and adds the generated instruction to the value read from the table, to generate a vector instruction stream. In addition, the ITT module 1220 may further generate a related control signal and the like and include it in an instruction packet of a translated instruction stream.

According to an embodiment, a data value of the register file used by the ITT module 1220 may be obtained via either (i) a complier device-dedicated register read port having direct access to the register file or (ii) a separate buffer memory that updates and stores the data value of the register file in real time.

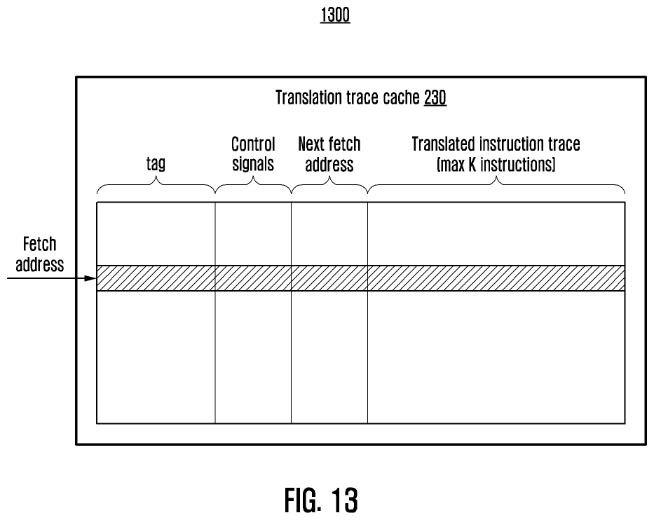

FIG. 13 illustrates an example structure 1300 of the TTC 120 according to one or more embodiments.

The TTC 120 may be implemented in the form of a cache memory. In this case, information stored in the TTC 120 may include a start PC value (tag) of a basic block of input instruction streams, an end PC value (next fetch address) of the basic block of the input instruction streams, related control signals, and a vector instruction stream (maximally, K) which is a target of translation. In an exceptional case where the vector instruction stream which is the target of translation includes K or more instructions, a subsequent TTC entry address value may be stored in the “next fetch address.”

Based on a current PC value, the TTC 120 may determine whether there is a stored record of previously performing translation of at least one instruction stream into a vector instruction stream. When the record is present, the following operations may be performed by the computing device.
(1) Determine, via the TTC 120, start and end address values of an instruction required to be translated, and flush instructions between these address values from the buffer memory 130.
(2) Set a subsequent PC value to a subsequent value of the end address value of the instruction required to be translated.
(3) Simultaneously, input, to the buffer memory 130, a vector instruction stream which is a result of performing the translation stored in the TTC 120.
(4) If necessary, stall operations in the “instruction fetch” stage of the core pipeline 100 and perform the vector instruction stream first. If there is no previous record stored, the computing device may store, in the TTC 120, the result of performing the translation after the translation by the compiler device 140 is completed.

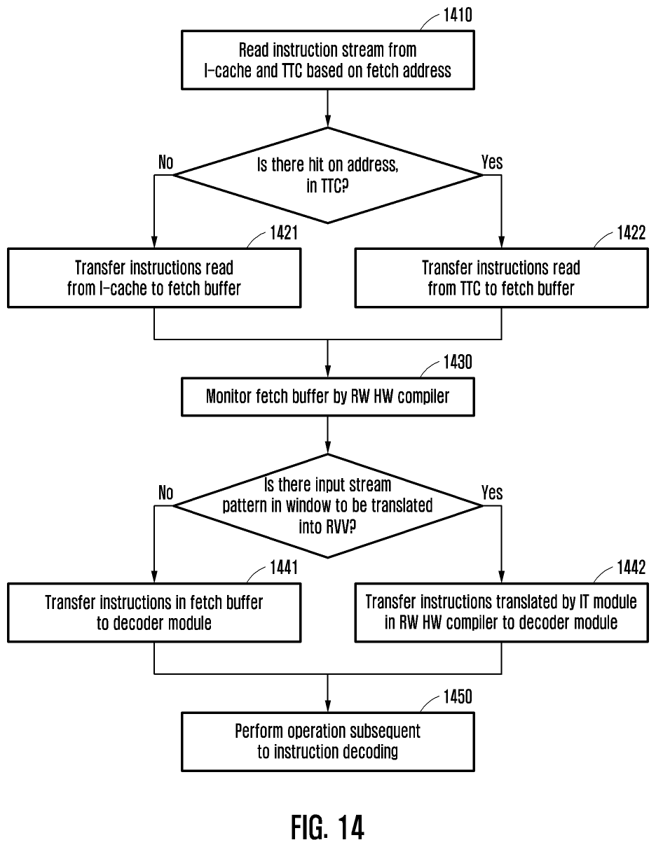

FIG. 14 illustrates an example flow of operations performed by a computing device according to one or more embodiments.

According to an embodiment, the computing device may include the instruction cache (I-Cache), the TTC 120, the buffer memory 130, and the compiler device 140, in the core pipeline 100.

At operation 1410, the computing device may read an instruction stream using an instruction cache (e.g., I-Cache) and the TTC (e.g., the TTC 120) based on a fetch address value (e.g., a current PC value).

At operation 1421, in the absence of a record (see “No” for “hit on address in TTC?” in FIG. 14) of translation into a vector stream corresponding to the fetch address value in the TTC, the computing device may transfer an instruction stream read from the instruction cache to the buffer memory 130.

At operation 1422, in the presence of the record (e.g., see “Yes” for “hit on address in TTC?” in FIG. 14) of translation into the vector stream corresponding to the fetch address value in the TTC, the computing device may transfer an instruction stream read from the TTC to the buffer memory 130.

At operation 1430, the computing device may monitor the buffer memory 130 by the compiler device 140.

At operation 1441, when there is no instruction stream translatable into a vector instruction stream, of at least one instruction stream including a predefined number of instructions corresponding to the speculative instruction window 410, based on the monitoring at operation 1430, the computing device may transfer instructions in the buffer memory 130 to a decoder.

At operation 1442, when there is an instruction stream translatable into a vector instruction stream, of the at least one instruction stream including the predefined number of instructions corresponding to the speculative instruction window 410, based on the monitoring at operation 1430, the computing device may transfer, to the decoder, the vector instruction stream output from the output module 230 in the compiler device 140.

At operation 1450, the computing device may perform a subsequent operation after the “instruction decode” stage in the core pipeline 100.

The examples described herein may be implemented using hardware components, software components and/or combinations thereof. A processing device may be implemented using one or more general-purpose or special purpose computers, such as, for example, a processor, a controller, an arithmetic logic unit (ALU), a digital signal processor, a microcomputer, a field programmable gate array (FPGA), a programmable logic unit (PLU), a microprocessor, or any other device capable of responding to and executing instructions in a defined manner. The processing device may run an operating system (OS) and one or more software applications that run on the OS. The processing device also may access, store, manipulate, process, and create data in response to execution of the software. For the purpose of simplicity, the description of a processing device is used as singular; however, one skilled in the art will be appreciated that a processing device may include multiple processing elements and multiple types of processing elements. For example, a processing device may include multiple processors or a processor and a controller. In addition, different processing configurations are possible, such as, parallel processors.

The software may include a computer program, a piece of code, instructions, or some combinations thereof, to independently or collectively instruct or configure the processing device to operate as desired. The software and/or data may be embodied permanently or temporarily in any type of machine, component, physical or virtual equipment, computer storage medium or device, or in a propagated signal wave capable of providing instructions or data to or being interpreted by the processing device. The software also may be distributed over network-coupled computer systems so that the software is stored and executed in a distributed fashion. The software and data may be stored by one or more non-transitory computer-readable recording mediums.

The methods according to the above-described examples may be recorded in non-transitory computer-readable media including program instructions to implement various operations of the above-described examples. The media may also include, alone or in combination with the program instructions, data files, data structures, and the like. The program instructions recorded on the media may be specially designed and constructed for the purposes of examples, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as ROM, RAM, flash memory (e.g., USB flash drives, memory cards, memory sticks, etc.), and the like. Examples of program instructions include both machine code, such as produced by a compiler, and files containing higher-level code that may be executed by the computer using an interpreter.

The above-described hardware devices may be configured to act as one or more software modules in order to perform the operations of the above-described examples, or vice versa.

The computing apparatuses, the electronic devices, the processors, the memories, the information output system and hardware, the storage devices, and other apparatuses, devices, units, modules, and components described herein with respect to FIGS. 1-14 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-14 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card micro or a card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. A computing device comprising:
one or more processors; and
memory storing instructions configured to cause the one or more processors to:
receive and decode an instruction stream comprising instructions and pieces of instruction-information respectively corresponding to the instructions;
determine whether the instructions in the instruction stream are translatable into a vector instruction stream based on the pieces of instruction-information; and
based on a result of the determining, translate the instructions of the instruction stream to a vector instruction stream, the translating comprising translating at least some of the instructions of the instruction stream to vector instructions in a vector-specific instruction set by replacing scalar instructions of a first instruction set architecture (ISA) with functionally equivalent vector instructions of a vector-specific ISA.

2. The computing device of claim 1, wherein the determining includes:
sequentially determining whether portions of instructions of the instruction stream match a predefined scalar instruction pattern based on pieces of instruction-type information of the portions of the instructions, and based thereon, determining whether the instruction stream matches the scalar instruction pattern.

3. The computing device of claim 2, wherein the determining whether the instructions in the instruction stream are translatable into a vector stream includes:
deriving a first address values of portions of the instructions determined to match; and
generating a second address value for translation into a vector instruction of the vector instruction stream by integrating the first address values.

4. The computing device of claim 2, wherein the scalar instruction pattern comprises at least one of:
a first scalar instruction pattern comprising a backward branch instruction; or
a second scalar instruction pattern comprising a forward branch instruction and a backward unconditional jump instruction.

5. The computing device of claim 1, wherein the determining whether the instructions in the instruction stream are translatable into a vector stream includes:
determining, based on source register information and destination register information of the instructions comprised in the instruction stream, the presence or absence of a register association between the instructions;
when there is an absence of an association between the instructions, determining that the instruction stream is not translatable into a vector instruction stream; and
when there is a presence of an association between the instructions, determining that the instruction stream is translatable into a vector instruction stream.

6. The computing device of claim 3, wherein the instructions are further configured to cause the one or more processors to:
in response to the second address value, translate the instruction stream into the vector instruction stream.

7. The computing device of claim 1, wherein the instructions are further configured to cause the one or more processors to:
when there is an instruction to be translated to a vector instruction using a register value for the instruction stream, translate the instruction stream into the vector instruction stream using the register value obtained through an access device.

8. The computing device of claim 1, further comprising:
a cache memory device configured to store a record of translating the instruction stream into the vector instruction stream,
wherein, in the presence of the record stored in the cache memory device, the instruction stream is flushed from a buffer memory and the vector instruction stream is inputted to the buffer memory.

9. The computing device of claim 1, further comprising:
a buffer memory; and
a decoder,
wherein the decoder is configured to:
receive the instruction stream from the buffer memory or receive the vector instruction stream from a module that performs the translating,
and wherein the instructions are further configured to cause the one or more processors to:
receive a second instruction stream comprising second instructions from the buffer memory, and
transfer the translated vector instruction stream to the decoder.

10. The computing device of claim 1, wherein the instruction stream comprises a predefined number of instructions.

11. The computing device of claim 1, further comprising:
a memory device,
wherein the memory device is configured to perform at least one of:
storing a new scalar instruction pattern;
determining whether the instruction stream is translatable into the vector instruction stream based on the new scalar instruction pattern; or
transferring the new scalar instruction pattern to a module that performs the translating.

12. A binary instruction translation method comprising:
receiving and decoding an instruction stream comprising instructions and pieces of instruction-information respectively corresponding to the instructions;
determining whether the instructions in the instruction stream are translatable into a vector instruction stream based on the pieces of instruction-information; and
based on a result of the determining, translate the instructions of the instruction stream to a vector instruction stream, the translating comprising translating at least some of the instructions of the instruction stream to vector instructions in a vector-specific instruction set by replacing scalar instructions of a first instruction set architecture (ISA) with functionally equivalent vector instructions of a vector-specific ISA.

13. The binary instruction translation method of claim 12, wherein the determining of whether the instruction stream is translatable comprises:
sequentially determining whether portions of the instruction stream match any of predefined scalar instruction patterns based on indications of opcodes of the respective instructions comprised in the instruction stream.

14. The binary instruction translation method of claim 13, wherein the determining of the matching with any of the scalar instruction patterns comprises:
deriving a first address values for each portion that matches one of the scalar instruction patterns; and
generating a second address value for translation into a vector instruction of the vector instruction stream by integrating the first address values.

15. The binary instruction translation method of claim 13, wherein the scalar instruction patterns comprise:
a first scalar instruction pattern comprising an indication of a backward branch instruction; and
a second scalar instruction pattern comprising an indication of a forward branch instruction and a backward unconditional jump instruction.

16. The binary instruction translation method of claim 12, wherein the determining of whether the instruction stream is translatable comprises:
determining, based on source register information and destination register information of the instructions comprised in the instruction stream, the presence or absence of a register association between a pair of the instructions;
when determined that there is an absence of an association, determining the instruction stream to be not translatable into a vector instruction stream; and
when determined that there is a presence of an association, determining the instruction stream to be translatable into a vector instruction stream.

17. The binary instruction translation method of claim 14, wherein the translating the instruction stream into the vector instruction stream is based on the second address value.

18. The binary instruction translation method of claim 12, wherein when there is an instruction to be translated using a register value for the instruction stream, translating the instruction stream into the vector instruction stream using the register value, wherein the register value is obtained through an access device.

19. The binary instruction translation method of claim 12, wherein, based on the presence, in a translation trace cache (TTC) memory, of a record of translating the instruction stream into the vector instruction stream:
flushing the instruction stream from a buffer memory; and
inputting the vector instruction stream to the buffer memory.

20. The binary instruction translation method of claim 12, further comprising:
transferring the instruction stream to an external memory based on the determining, and determining whether the instruction stream matches a new scalar instruction pattern newly stored in the memory; or
loading the new scalar instruction pattern into a device that performs the translating from the memory storing the new scalar instruction pattern.
